(19) United States
(12) Patent Application Publication
(10) Pub. No.: US 2016/0331177 A1
(43) Pub. Date: Nov. 17, 2016

(54) Cooking Systems and Implements

(71) Applicant: Roy W Kirby, Groveland, MA (US)

(72) Inventor: Roy W Kirby, Groveland, MA (US)

(21) Appl. No.: 14/709,898

(22) Filed: May 12, 2015

(51) Int. Cl. A47J 37/07; A23L 1/01

(52) U.S. Cl. CPC A47J 37/0786; A23L 1/01

(57) ABSTRACT

Cooking systems and implements are discussed here. Such systems and implements support edible products, for example meats on a grill. A cooking implements may include a substantially horizontal member, one or more support member and an attaching member.

### BACKGROUND

The present technology relates to cooking systems, implements and methods for supporting edible products.

Current cooking accessories include various structures to hold an item of food. In existing cooking systems the cooking implements can only be used with a single accompanying cooking base, and are very difficult to clean. Existing cooking systems also accommodate only certain sizes of food items, and it is difficult to remove the food items after they are cooked. Existing cooking systems also occupy a great amount of space and are inefficient in their use of space. Existing cooking systems further do not provide sufficient support for food items with different shapes and different sizes. Lastly, existing cooking systems often take up a substantial amount of space and are difficult to store and transport.

Thus, a need exists for cooking systems and implements that are easy to use, clean, store and transport.

### BRIEF SUMMARY

In certain embodiments, the present technology provides a cooking system comprising:
a) a cooking implement including:
   i) a substantially horizontal member;
   ii) a first support member having a proximal end attached at a first end of the substantially horizontal member and a distal end of the support member extending upwardly from the substantially horizontal member; and
   iii) an attaching member located at a point on the substantially horizontal member in a manner that removably attaches to a cooking grid; and
b) a cooking grid having a cooking surface that supports the attaching member of the substantially horizontal member, stabilizing the cooking implement onto the cooking grid.

In certain embodiments, the present technology provides a cooking implement comprising:
a) a substantially horizontal member;
b) a first support member having a proximal end attached at a first end of the substantially horizontal member and a distal end of the support member extending upwardly from the substantially horizontal member; and
c) an attaching member located at a point on the substantially horizontal member in a manner that removably attaches to a cooking grid.

In certain embodiments, the present technology provides a method of cooking an item of food, the method comprising the following steps:
a) obtaining a cooking implement with a substantially horizontal member; a first support member having a proximal end attached at a first end of the substantially horizontal member and a distal end of the support member extending upwardly from the substantially horizontal member; and an attaching member located at a point on the substantially horizontal member in a manner that removably attaches to a cooking grid;
b) placing the item of food on the cooking implement; and
c) attaching the cooking implement onto a cooking grid.

### BRIEF DESCRIPTION OF THE DRAWINGS

FIG. 1 is a first perspective view of an embodiment of the present technology.

FIG. 2 is a second perspective view of an embodiment of the present technology.

FIG. 3 is a third perspective view of an embodiment of the present technology.

FIG. 4 is a fourth perspective view of an embodiment of the present technology.

FIG. 5 is a fifth perspective view of an embodiment of the present technology.

### DETAILED DESCRIPTION

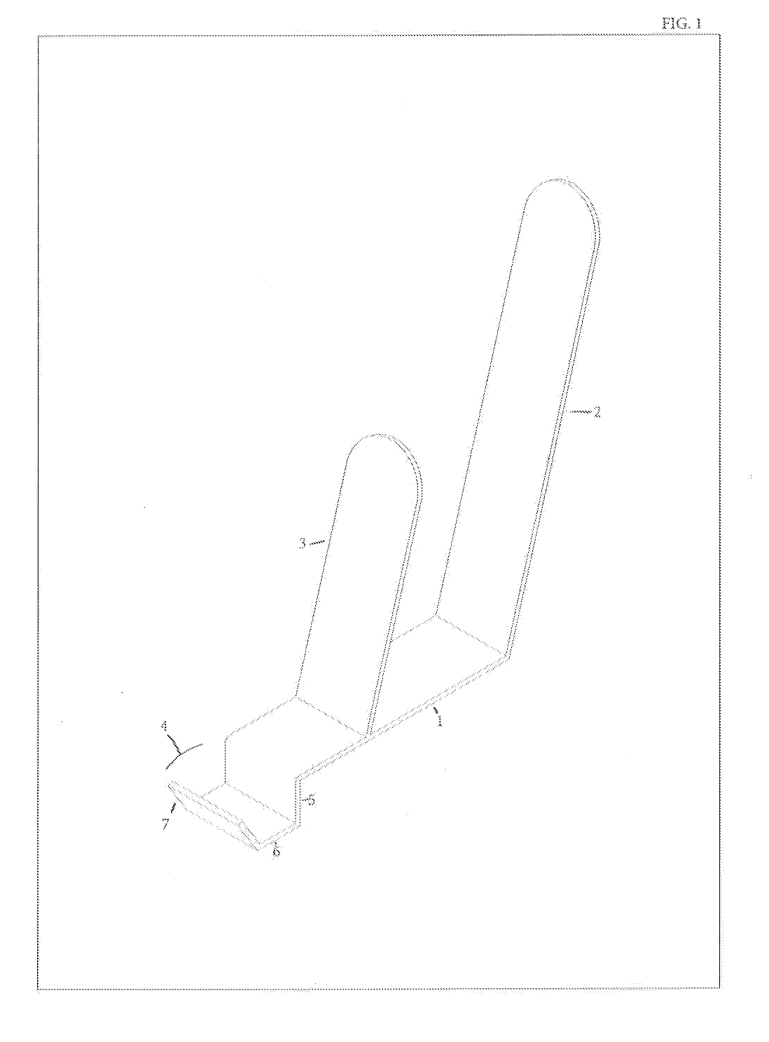

In certain embodiments, the present technology provides a cooking system comprising, as shown in an exemplary embodiment in FIG. 1, a cooking implement with a substantially horizontal member 1, a first support member 2 having a proximal end attached at a first end of the substantially horizontal member and a distal end of the support member extending upwardly from the substantially horizontal member, and an attaching member 4 located at a point on the substantially horizontal member in a manner that removably attaches to a cooking grid.

In certain embodiments, the cooking system further includes a cooking grid 8 having a cooking surface that supports the attaching member of the substantially horizontal member, stabilizing the cooking implement onto the cooking grid.

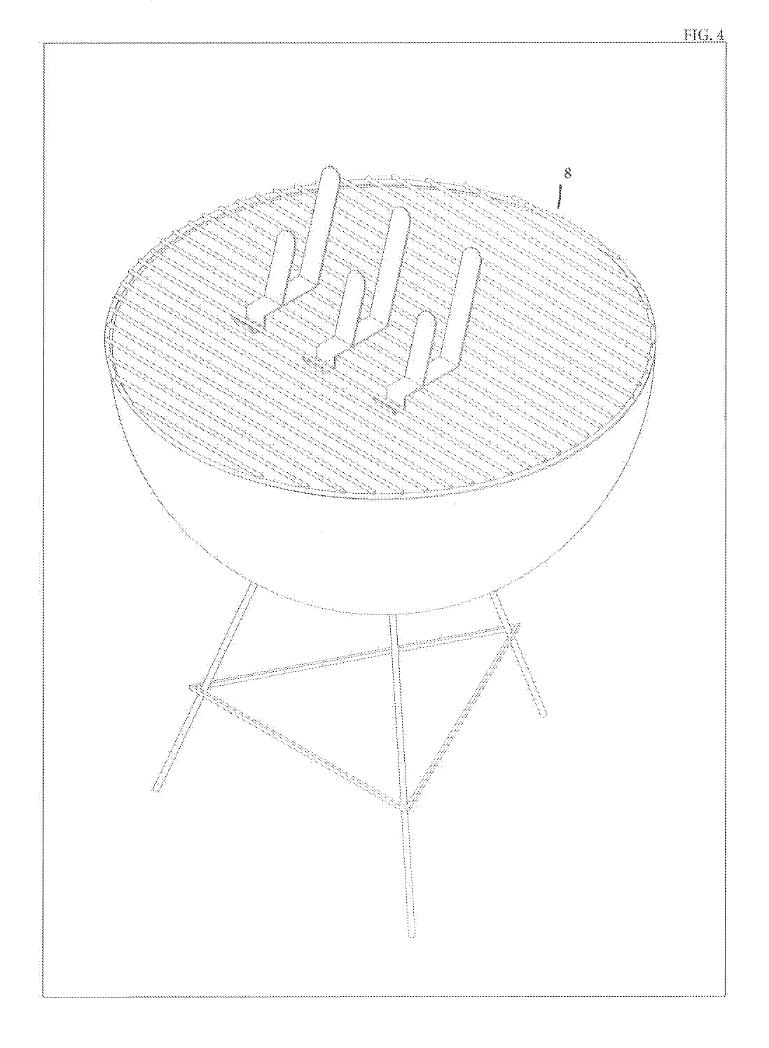

In certain embodiments, the cooking system comprises a second cooking implement 3 configured substantially in parallel with the first cooking implement such that an item of food is held within the two cooking implements. As shown in an exemplary embodiment in FIG. 4, in certain embodiments, multiple cooking implements are configured to support an item of food along the length of the food item. FIG. 4 shows an exemplary embodiment of three cooking implements attached to a cooking grid. In certain embodiments, the first cooking implement and the second cooking implement are configured to support an item of food along the width of the food item.

In certain embodiments, the user decides where on the cooking grid to place the cooking implement, or the number of cooking implements to use per item of food. The user's ability to decide where and in what direction to attach the cooking implements to the cooking grid helps save space and ease the placement, cooking and removal of the food item.

In certain embodiments, the present technology provides a cooking system wherein a second support member is attached to the substantially horizontal member and extending upwardly from the substantially horizontal member of the cooking implement such that an item of food can be kept in place on the cooking implement between the first and second support members. In various embodiments, the first support member is the same length as, or a different length from the second support member. In certain embodiments the item of food rests in between the first and the second support member.

The present technology, in certain embodiments, provides a cooking system wherein the cooking implement further comprises a third support member attached to the substantially horizontal member and extending upwardly from the substantially horizontal member such that an item of food can be kept in place between any two of the support members on the cooking implement. In various embodiments, the third support member is the same length as, or a different length from one or both of the first and second support members.

In certain embodiments, each support member is a different length or two or more of the support members are the same length. In certain embodiments the length of one or more support members is about 1 to about 3 inches, or about 3 to about 5 inches, or about 5 to about 6 inches, or about 6 to about 12 inches.

In certain embodiments the width of one or more support members is about ½ to about 1½ inches, or about 1 inch.

In certain embodiments, the substantially horizontal member has essentially no slope. As used herein, “essentially no slope” means the member is horizontal or flat, that is, it lies at an angle of 0 degrees or less than about 5 degrees, as measured from the horizontal plane. In other embodiments, the substantially horizontal member has a slope of about 1 to about 10 degrees, 0 to about 25 degrees, or about 10 to about 25 degrees.

In certain embodiments, the substantially horizontal member of the first cooking implement is attached by a connecting member to the substantially horizontal member of a second cooking implement, thereby forming a unified, multi-part cooking implement. The connecting member can be permanently or removably attached to one or more of the individual cooking implements.

In certain embodiments, the first support member of a cooking implement is attached by a connecting member to a first support member or a second support member of a second cooking implement. In certain embodiments, the second support member of a cooking implement is attached by a connecting member to a first support member or a second support member of a second cooking implement.

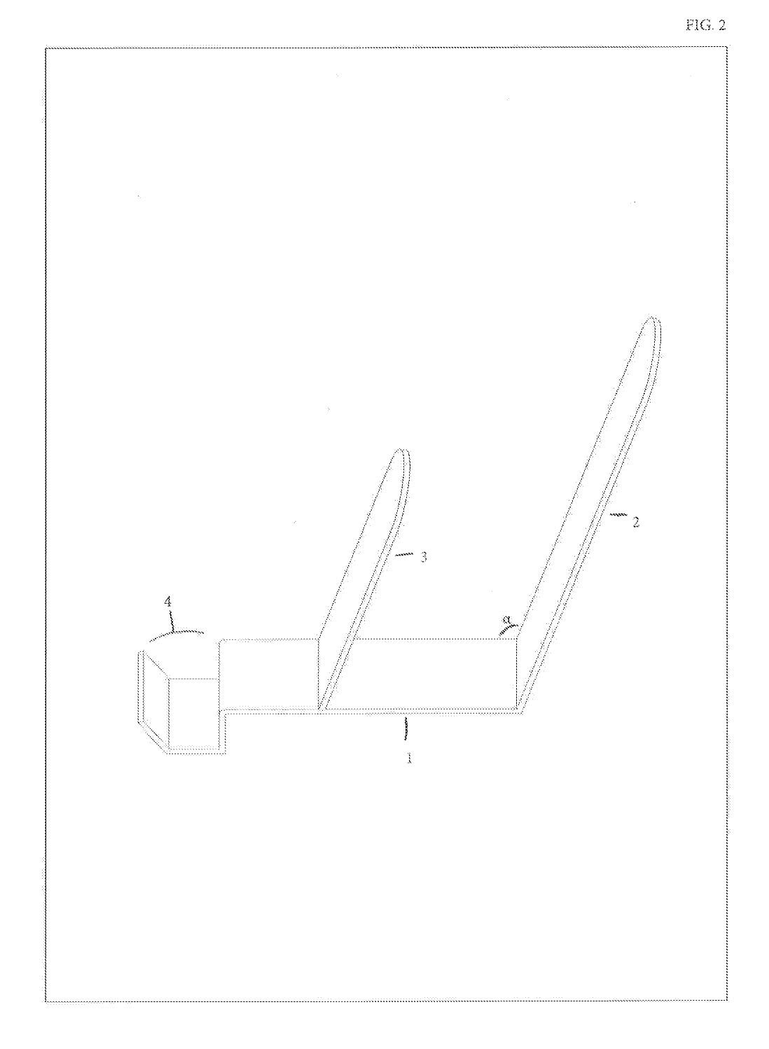

In certain embodiments, one or more of the support members are tilted with respect to the substantially horizontal member, for example, as shown in angle α of FIG. 2. That is, the support member forms any angle α other than about 90 degrees from horizontal with the substantially horizontal member. As shown in an exemplary embodiment in FIG. 2, in certain embodiments one or more of the first support members form an angle α of about 90 degrees, about 88 to about 92 degrees, about 90 to about 100 degrees, about 100 to about 105 degrees, about 105 to about 110 degrees, or about 110 to about 130 degrees with the substantially horizontal member.

In certain embodiments, the present technology provides a cooking system wherein the attaching member is configured to contact the underside of the cooking grid.

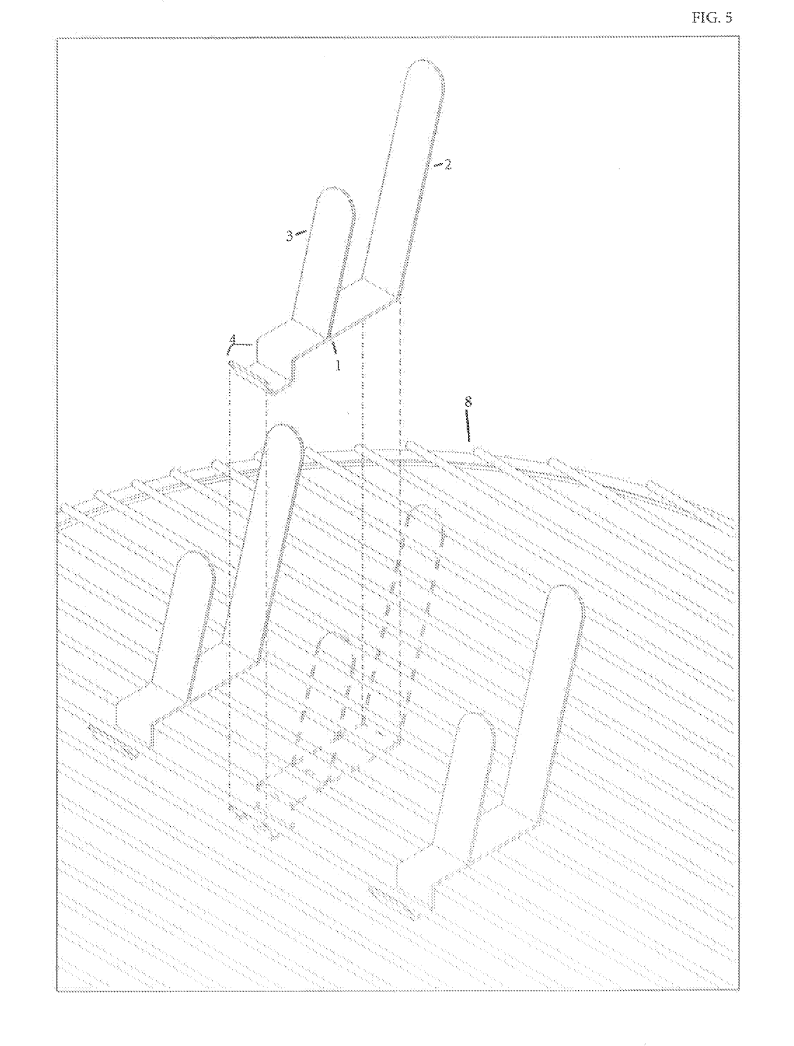

In certain embodiments, the cooking implement of the cooking system comprises an attaching member 4 configured to clip onto the cooking grid 8. As used herein, a “clip” refers to a device that removably grasps, clasps or hooks onto the cooking grid, for example as seen in FIG. 5.

As used herein, “substantially horizontal” means within 25 degrees of 0 degrees on the horizontal plane.

In certain embodiments, the attaching member is configured to lock onto the underside of the cooking grid. As used herein, “lock” refers to any mechanism that removably attaches the cooking implement to the cooking grid, including, for example, a magnetic lock, tailgate lock, or twist lock.

In certain embodiments, for example, as shown in FIG. 1 the locking mechanism encompasses a first downwardly extending attaching member 5, attached to horizontal attaching member 6 that is attached to upwardly extending attaching member 7. In certain embodiments the attaching member 4 extend from one end of the substantially horizontal member 1, and are placed as to surround the sides and bottom of a bar on a cooking grid 8. The exemplary embodiment in FIG. 5 shows one configuration with the insertion of the cooking implement into the cooking grid.

In certain embodiments the substantially horizontal member of the cooking implement is raised above the surface of the cooking grid, such that the item of food rests on the substantially horizontal member of the cooking implements and does not come in contact with the cooking grid. Such embodiment is important for various reasons including sanitary reasons and to keep the item of food further from the heat source.

In certain embodiments, the present technology provides a cooking implement comprising a substantially horizontal member, a first support member having a proximal end attached at a first end of the substantially horizontal member and a distal end of the support member extending upwardly from the substantially horizontal member, and an attaching member located at a point on the substantially horizontal member in a manner that removably attaches to a cooking grid.

The present technology in certain embodiments provides, a cooking implement wherein the cooking implement further comprises a second support member attached to the substantially horizontal member and extending upwardly from the substantially horizontal member such that an item of food can be kept in place on the cooking implement between the first and second support members.

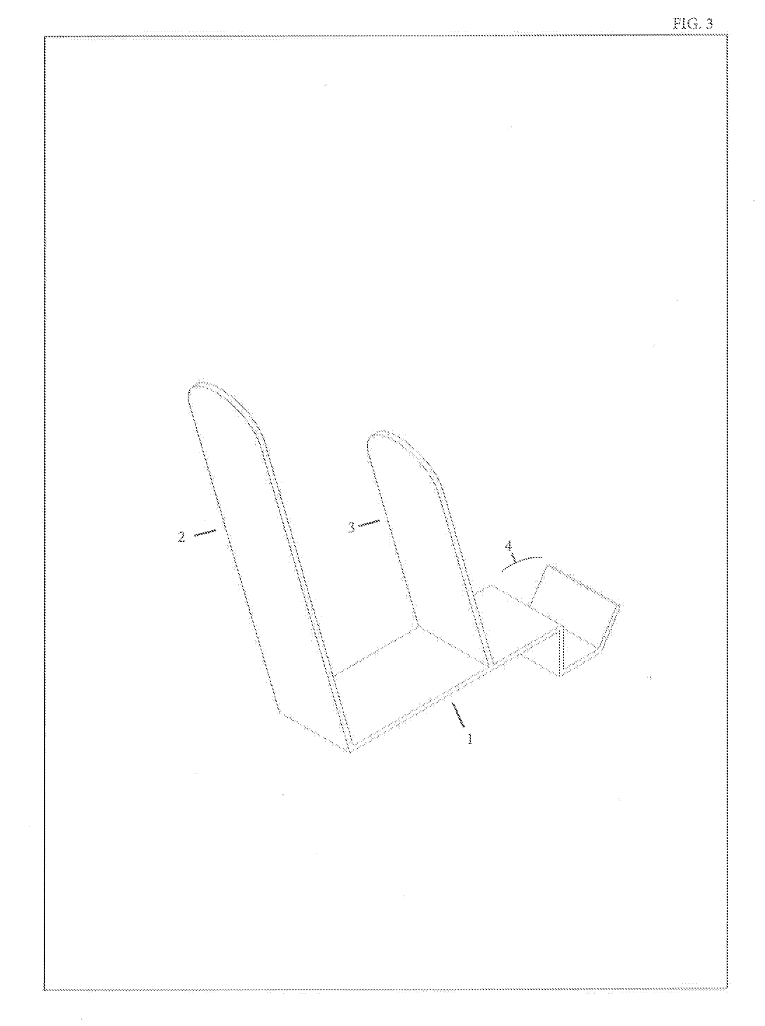

In certain embodiments, one or more surfaces of one or more of the support members is flat. In certain embodiments, one or more surfaces of one or more of the support members is smooth. In other embodiments, the support members have ridges capable of supporting further accessories, including, for example, shelves for the cooked food item. FIG. 3 shows an exemplary embodiment where the first support member 2 and second support member 3 are flat and smooth.

In certain embodiments, the cooking implement holds a portion of meat, including but not limited to ribs, steak, bacon, and lamb chops. In other embodiments, the present technology holds a portion of poultry, including but not limited to legs and wings. In other embodiments, the present technology holds a portion of fish. In other embodiments, the present technology holds a portion of bread, vegetables, grain or fruit, including but not limited to peppers, eggplants, corn and mushrooms. Any item of food can be cooked or heated using the systems and implements herein.

In certain embodiments, the implement in the present technology is attached to a barbecue or other type of grill. In other embodiments, the implement in the present technology is attached to a stovetop, a grill pan, a roasting pan, a broiler pan, or a rack including but not limited to a roasting rack, oven rack or a broiler rack.

In certain embodiments, the present technology provides a method of holding in position an item of food comprising the steps of obtaining a cooking implement with a substantially horizontal member, a first support member having a proximal end attached at a first end of the substantially horizontal member and a distal end of the support member extending upwardly from the substantially horizontal member, and an attaching member located at a point on the substantially horizontal member in a manner that removably attaches to a cooking grid, attaching the cooking implement onto a cooking grid and placing the item of food on the cooking implement.

The method can, in certain embodiments, further comprise step of applying heat to the item of food in order to warm up or cook the food.

In certain embodiments, the present technology provides a method further comprising the following step of placing a second cooking implement as in step (a) configured substantially in parallel with the first cooking implement such that an item of food is held within the two cooking implements.

1. A cooking system comprising:
a. a first cooking implement including:
i. a substantially horizontal member;
ii. a first support member having a proximal end attached at a first end of the substantially horizontal member and a distal end of the first support member extending upwardly from the substantially horizontal member;
iii. an attaching member located at a point on the substantially horizontal member in a manner that removably attaches to a cooking grid;
b. a second cooking implement according to claim 1a, configured substantially in parallel with the first cooking implement such that an item of food is held within the two cooking implements; and
c. a cooking grid having a cooking surface that supports the attaching member of the substantially horizontal member, stabilizing the cooking implement thereon.

2. (canceled)

3. The cooking system of claim 1, wherein the cooking implement further comprises a second support member attached to the substantially horizontal member and extending upwardly from the substantially horizontal member such that an item of food can be kept in place on the cooking implement between the first and second support members.

4. The cooking system of claim 3, wherein the cooking implement further comprises a third support member attached to the substantially horizontal member and extending upwardly from the substantially horizontal member such that an item of food can be kept in place between any two of the support members on the cooking implement.

5. The cooking system of claim 1, wherein the substantially horizontal member of the first cooking implement is attached by a connecting member to the substantially horizontal member of the second cooking implement.

6. The cooking system of claim 3, wherein the first support member of the first cooking implement is attached by a connecting member to the first support member of the second cooking implement or the second support member of the second cooking implement.

7. The cooking system of claim 1, wherein the attaching member is configured to contact the underside of the cooking grid.

8. The cooking system of claim 1, wherein the attaching member is configured to clip onto the cooking grid.

9. The cooking system of claim 1, wherein the attaching member is configured to lock onto the underside of the cooking grid.

10. The cooking system of claim 1, wherein the substantially horizontal member of the cooking implement is raised above the surface of the cooking grid, such that the item of food rests on the substantially horizontal member of the cooking implements and does not come in contact with the cooking grid.

11. A cooking implement comprising:
a. a substantially horizontal member;
b. a first support member having a proximal end attached at a first end of the substantially horizontal member and a distal end of the first support member extending upwardly from the substantially horizontal member;
c. a second support member attached to the substantially horizontal member and extending upwardly from the substantially horizontal member such that an item of food can be kept in place on the cooking implement between the first and second support members; and
d. an attaching member located at a point on the substantially horizontal member in a manner that removably attaches to a cooking grid.

12. (canceled)

13. The cooking implement of claim 11, wherein the first support member is a different length from the second support member.

14. The cooking implement of claim 11, wherein the attaching member is configured to contact the underside of the cooking grid.

15. The cooking implement of claim 11, wherein the attaching member is configured to clip onto the cooking grid.

16. The cooking implement of claim 11, wherein the attaching member is configured to lock onto the underside of the cooking grid.

17. The cooking implement of claim 11, wherein the substantially horizontal member of the cooking implement is raised above the surface of the cooking grid, such that the item of food rests on the substantially horizontal member of the cooking implements and does not come in contact with the cooking grid.

18. A method of cooking an item of food, the method comprising the following steps:
A. obtaining a cooking implement with a substantially horizontal member; a first support member having a proximal end attached at a first end of the substantially horizontal member and a distal end of the support member extending upwardly from the substantially horizontal member; and an attaching member located at a point on the substantially horizontal member in a manner that removably attaches to a cooking grid;
B. attaching the cooking implement onto a cooking grid; and
C. placing the item of food on the cooking implement.

19. The method of claim 18, wherein the cooking implement further comprises a second support member attached to the substantially horizontal member and extending upwardly from the substantially horizontal member such that an item of food is held in place on the cooking implement between the first and second support members.

20. The method of claim 18, further comprising the following step of placing a second cooking implement as in step (a) configured substantially in parallel with the first cooking implement such that an item of food is held within the two cooking implements.
